(19) United States
(12) Patent Application Publication
(10) Pub. No.: US 2022/0053068 A1
(43) Pub. Date: Feb. 17, 2022

(54) METHODS, APPARATUSES AND COMPUTER STORAGE MEDIA FOR APPLET STATE SYNCHRONIZATION

(71) Applicant: Shanghai Lianshang Network Technology Co., Ltd., Shanghai (CN)

(72) Inventor: Han CHENG, Shanghai (CN)

(21) Appl. No.: 17/453,092

(22) Filed: Nov. 1, 2021

Related U.S. Application Data
(63) Continuation of application No. PCT/CN2020/087145, filed on Apr. 27, 2020.

(30) Foreign Application Priority Data
Apr. 30, 2019 (CN) 201910358612.0

(51) Int. Cl. H04L 29/08; G06F 9/445

(52) U.S. Cl. CPC H04L 67/34; G06F 9/4451; H04L 67/10

(57) ABSTRACT

The present disclosure provides a method, a device, and a computer storage medium for state synchronization of mini programs. The method comprises: uploading, by a first terminal device, running state data of a mini program which is currently running to a server, so that the server synchronizes the running state data to an identical mini program which runs on a second terminal device with a same account. State synchronization of mini programs across devices is enabled in the present application.

### CROSS REFERENCE TO THE RELATED APPLICATION

This application is a continuation of International Application No. PCT/CN2020/087145, filed Apr. 27, 2020, which claims the benefit of priority to Chinese Patent Application No. 201910358612.0, filed Apr. 30, 2019, the benefit of priority of each of which is claimed herein and which applications are hereby incorporated by reference herein in their entirety.

### TECHNICAL FIELD

The present disclosure relates to computer applications, and particularly relates to a method, a device and a computer storage medium for state synchronization of mini programs.

### BACKGROUND

This section is intended to provide background or context for the embodiments of the present disclosure as set forth in the claims. The description herein shall not be considered as the prior art by virtue of its inclusion in this section.

A mini program is a type of application that can be used without downloading and installing, and runs in an environment provided by a host application. The mini program is more and more widely used because it is readily accessible without installation or uninstallation. Nowadays, many users have multiple terminal devices and usually log in identical mini programs on various terminal devices with a same account. However, at present, when the mini program is opened with the same account on one of the various terminals, only local running states can be obtained. For example, when a user opens a gaming mini program 1 on a tablet with account b after he operated the same gaming mini program 1 on a mobile phone with account a, the user is able to obtain only the running state data generated when he operated gaming mini program 1 on the tablet last time, but is unable to obtain the running state data generated when he operated gaming mini program 1 on the mobile phone, which often brings inconvenience to the user.

### SUMMARY

In view of this, the present disclosure provides a method, device and computer storage medium for state synchronization of mini programs to achieve state synchronization of mini programs across devices.

The technical solutions are specifically provided as follows.

In a first aspect, the present disclosure provides a method for state synchronization of mini programs. The method comprises:

uploading, by a first terminal device, running state data of a mini program which is currently running to a server, so that the server synchronizes the running state data to an identical mini program which runs on a second terminal device with a same account.

According to an embodiment of the present disclosure, the running state data comprises: data in memory stack or data in running state cache of the mini program;

wherein the running state cache comprises: cookie or localstorage.

According to an embodiment of the present disclosure, before uploading, by the first terminal device, the running state data of the mini program which is currently running to the server, the method further comprises:

determining, by the first terminal device, whether the mini program is a mini program which is configured with state synchronization permission; and if so, proceeding to upload the running state data of the mini program which is currently running to the server; otherwise, not uploading the running state data of the mini program which is currently running to the server.

According to an embodiment of the present disclosure, the uploading comprises: uploading the running state data of the mini program which has been changed in real time or periodically.

In a second aspect, the present application also provides a method for state synchronization of mini programs. The method comprises:

receiving and maintaining, by a server, running state data of a mini program which is currently running uploaded by a first terminal device; and

synchronizing the running state data to an identical mini program which runs on a second terminal device with a same account.

According to an embodiment of the present disclosure, the running state data comprises: data in memory stack or data in running state cache of the mini program;

wherein the running state cache comprises: cookie or localstorage.

According to an embodiment of the present disclosure, the server maintains correspondence between terminal device identification, account identification, mini program identification and the running state data, and wherein the running state data comprises time information.

According to an embodiment of the present disclosure, synchronizing the running state data to the identical mini program which runs on the second terminal device with the same account comprises:

receiving, by the server, a synchronization request from the second terminal device and synchronizing the latest running state data corresponding to the identical mini program with the same account to the second terminal device according to the correspondence; or

actively synchronizing the latest running state data corresponding to the identical mini program with the same account to the second terminal device according to the correspondence.

According to an embodiment of the present disclosure, the server actively synchronizes the latest running state data corresponding to the identical mini program with the same account to the second terminal device according to the correspondence if a mapping relationship for screen projection is established between the first terminal device and the second terminal device in advance.

According to an embodiment of the present disclosure, the method further comprises:

updating, by the server, running state data of the second terminal device maintained on the server with the running state data.

In a third aspect, the present disclosure also provides a method for state synchronization of mini programs. The method comprises:

receiving, by a second terminal device, running state data transmitted by a server, wherein the running state data is running state data of a mini program which is currently running uploaded by the first terminal device to the server; and

updating an identical mini program which runs on the second terminal device with a same account with the running state data.

According to an embodiment of the present disclosure, the running state data comprises: data in memory stack or data in running state cache of the mini program;

wherein the running state cache comprises: cookie or localstorage.

According to an embodiment of the present disclosure, before receiving, by the second terminal device, the running state data transmitted by the server, the method further comprises:

transmitting a synchronization request to the server when the identical mini program is opened on the second terminal device with the same account; or

transmitting a synchronization request to the server when the identical mini program is logged in with the same account on the second terminal device.

According to an embodiment of the present disclosure, before transmitting the synchronization request to the server, the method further comprises:

determining, by the second terminal device, whether the mini program is a mini program which is configured with state synchronization permission, and if so, proceeding to transmit the synchronization request to the server; otherwise, not transmitting the synchronization request to the server.

In a fourth aspect, the present application provides a device. The device comprises:

one or more processors; and

storage means for storing one or more programs, wherein the one or more programs, when executed by the one or more processors, cause the one or more processors to implement the above methods.

In a fifth aspect, the present application provides a storage medium comprising computer-executable instructions, wherein the computer-executable instructions are executed by a processor of a computer to implement the above methods.

As seen from the above technical solutions, in the present application, the first terminal uploads the running state data of a mini program which is currently running to the server, and the server maintains and synchronizes the running state data to the identical mini program which runs on the second terminal device with the same account, which realizes state synchronization of the mini programs across devices.

### DESCRIPTIONS OF THE DRAWINGS

FIG. 1 is a schematic diagram of a system architecture provided in embodiments of the present disclosure;

FIG. 2 is a main flowchart of a method provided in embodiments of the present disclosure;

FIG. 3 is a schematic diagram of a configuration interface provided in embodiments of the present disclosure;

FIG. 4 is a schematic diagram of a synchronization flow provided in Embodiment One of the present disclosure;

FIG. 5 is a schematic diagram of a synchronization flow provided in Embodiment Two of the present disclosure;

FIG. 6 is a schematic diagram of a synchronization flow provided in Embodiment Three of the present disclosure; and

FIG. 7 shows a block diagram of an exemplary computer system/server suitable for implementing the embodiments of the present disclosure.

### DETAILED EMBODIMENTS

To make the objects, technical solutions, and advantages of the present disclosure clearer, the present disclosure will be described in detail in conjunction with the accompanying drawings and specific embodiments below.

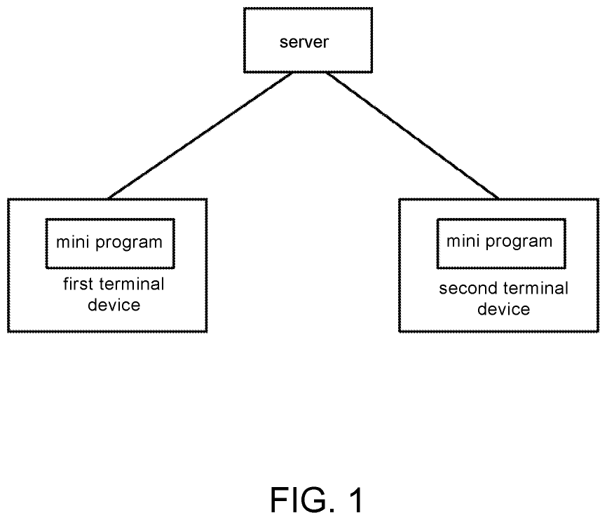

To facilitate understanding of the present disclosure, a brief description of a system architecture provided in the present disclosure is provided. As shown in FIG. 1, the system mainly comprises: a first terminal device, a server and a second terminal device. A user logs in and runs an identical mini program on the first terminal device and the second terminal device with a same account. The server is a server-side device corresponding to the mini program.

The mini program runs on the first terminal device and the second terminal device with dependence on a host application. An environment in which the mini program runs is provided by the host application. No modification or change to the functionality of the host application is provided by the present disclosure. The above mini program may run on the first terminal device and the second terminal device with dependence on the same host application, and may also run on the first terminal device and the second terminal device with dependence on different host applications. The present disclosure is not limited in this aspect.

The first terminal device and the second terminal device involved in embodiments of the present disclosure may include, but are not limited to, for example, smart mobile terminals, smart home devices, network devices, wearable devices, smart medical devices, PCs (personal computers), etc. The smart mobile devices may comprise, for example, mobile phones, tablet computers, laptops, personal digital assistants (PDA), Internet-capabled vehicles, etc. The smart home devices may comprise smart home electric appliances, such as smart TVs, smart speakers, etc. The network devices may comprise, for example, switches, wireless APs, servers, etc. The wearable devices may comprise, for example, smart watches, smart glasses, smart bracelets, virtual reality devices, augmented reality devices, mixed reality devices (i.e., devices which may support both virtual reality and augmented reality), etc.

It should also be noted that a scenario to which the present disclosure applies is not limited to a scenario where there are only two terminal devices such as the first terminal device and the second terminal device. The user may run an identical mini program on more than two terminal devices with the same account. The present disclosure is described in the context of two terminal devices as an example. Synchronization on other terminal devices may be implemented in the same way.

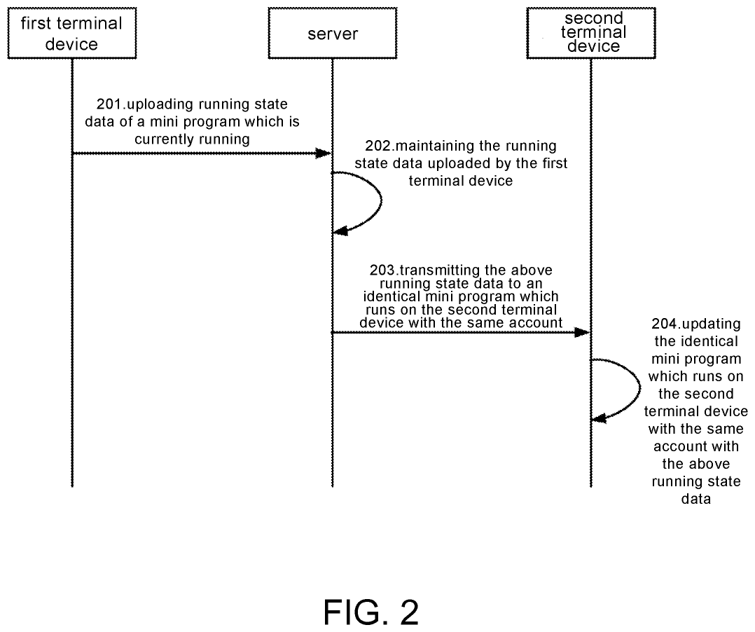

FIG. 2 is a main flowchart of a method provided in embodiments of the present disclosure. As shown in FIG. 2, the method mainly comprises the following steps.

In 201, a first terminal device uploads running state data of a mini program which is currently running to a server.

In embodiments of the present disclosure, the above running state data may include but is not limited to: data in memory stack or data in running state cache of the mini program.

For example, a running state of an interactive entertainment type mini program is recorded by a memory stack. The first terminal device may determine the memory stack occupied by the mini program and upload the data in memory stack.

For example, a running state of a mini program using webview such as a news type mini program is recorded by the running state cache such as cookie or localstorage.

The uploading involved in this step may be real-time or periodic uploading. The real-time uploading refers to uploading as soon as the running state data changes, and the periodic uploading refers to uploading with a fixed interval between two consecutive uploads.

When uploading, the entire data in memory stack or the entire data in running state cache of the mini program may be uploaded as a whole, which leads to a waste of performance and bandwidth of the terminal. Therefore, another way of uploading only the running state data which has been changed is preferred. In an example of a memory stack, upload may be implemented in a “slicing” way. That is, an area of the memory stack corresponding to the mini program which has been changed is determined, and data in the area is uploaded to the server. This is similar to slicing a memory into areas and uploading a “slice” of area.

The area of the memory stack corresponding to the mini program which has been changed may be determined in the following way: taking a snapshot of the memory stack of the mini program at various time. For example, a snapshot of the memory stack is taken at each time of uploading. A snapshot of the memory stack of the mini program is taken each time a new upload cycle arrives. Difference between the current snapshot and the last snapshot is determined by comparing the current snapshot and the last snapshot, and an address to the difference of the memory stack is exported and uploaded. The snapshot refers to a feature value generated according to the contents of the memory stack.

In 202, the server receives and maintains the running state data uploaded by the first terminal device.

Correspondence between terminal device identification, account identification, mini program identification and the running state data is maintained at the server. The running state data comprises time information which may be the time when the terminal device uploads the running state data. The server may be aware of the latest running state data of the identical mini program with the same account through the time information.

In 203, the server transmits the above running state data to the identical mini program which runs on the second terminal device with the same account.

The server may synchronize the running state data either through active push or in response to a request.

That is, the server may actively synchronize the latest running state data corresponding to the identical mini program with the same account to the second terminal device according to the above maintained correspondence.

The server may also synchronize the latest running state data corresponding to the identical mini program with the same account to the second terminal device according to the above maintained correspondence after receiving a synchronization request from the second terminal device.

Examples will be introduced later for the above two cases. The above synchronization request may be transmitted in response to a trigger as follows: a synchronization request is transmitted to the server when the identical mini program is opened on the second terminal device with the same account. For example, if a user opens a mini program on the second terminal device and the mini program has been logged in with the same account, the second terminal device is triggered by the opening of the mini program to transmit a synchronization request to the server, which at least contains identification of the second terminal device, mini program identification and account identification. The server locates a running state data record of the first terminal device corresponding to the same account identification and the identical mini program identification after receiving the synchronization request. If the server has not have the running state data corresponding to identification of the second terminal device, mini program identification and account identification recorded yet, or the maintained running state data corresponding to identification of the first terminal device, the above mini program identification and the above account identification is the latest, the server synchronizes the latest running state data to the second terminal device.

The above synchronization request may also be transmitted in response to a trigger as follows: a synchronization request is transmitted to the server when the above mini program is logged in with the above same account on the second terminal device. For example, if a user opens the above identical mini program on the second terminal device and logs in with the above same account during the use process, the second terminal device is triggered to transmit a synchronization request to the server. Content of the synchronization request is the same as what is described above and will not be repeated.

In 204, the second terminal device updates the identical mini program which runs on the second terminal device with the same account with the above running state data.

Accordingly, the second terminal device updates the local memory stack or running state cache corresponding to the identical mini program with the above running state data.

After the synchronization of the above running state data is completed, the server updates the running state data of the second terminal device maintained on the server with the running state data. After updating, the running state data corresponding to the identification of the second terminal device, the above mini program identification and the account identification maintained on the server is also the latest running state data with the time information being the same as that of the running state data of the identical mini program with the same account corresponding to the first terminal device.

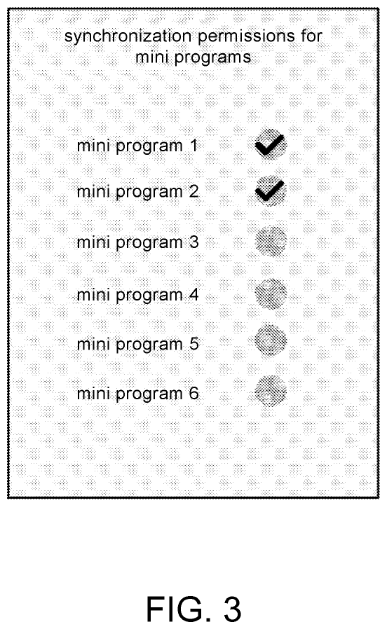

In addition, for the first terminal device or the second terminal device, which of the mini programs are permitted for state synchronization may be pre-configured by developers or configured by a user of the first terminal device or the second terminal device. For example, a configuration interface may be provided to the user, as shown in FIG. 3. The user selects one or more mini programs for which state synchronization is required on this configuration interface. The configuration interface may be uniformly provided by a host application of the mini program.

The operations executed by the devices in the above method may be executed by applications in the device or a functional unit such as a plug-in or Software Development Kit (SDK), etc., located at applications in the local terminal. For example, the above operations of the first terminal device and the second terminal device may be executed by a plug-in in the mini program in the first and second terminal devices. The above operations of the server may be executed by an application in the server.

The above method is described below by way of example in conjunction with three specific embodiments.

### Embodiment One

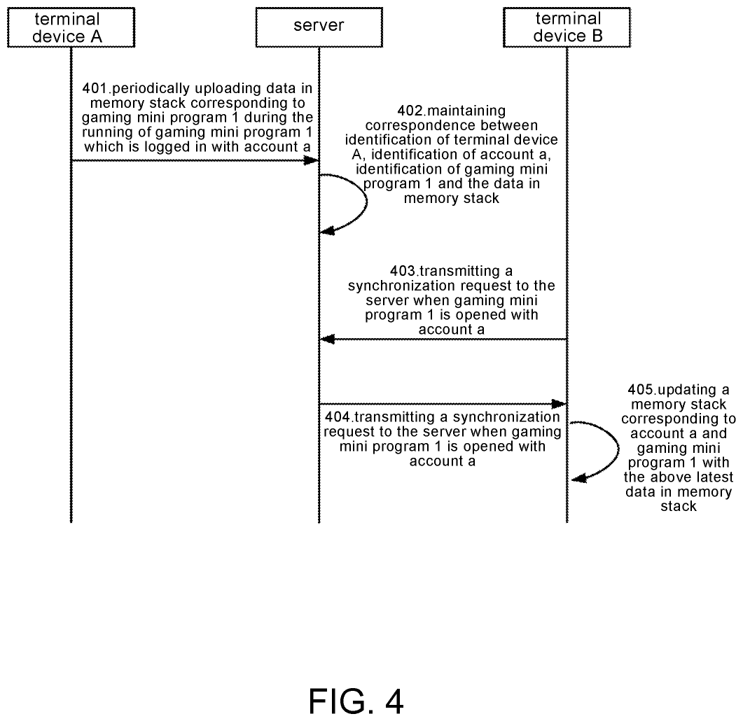

Hypothetically, after gaming mini program 1 is logged in by a user with account a on terminal device A, gaming mini program 1 is opened by the user on terminal device B, and is also logged in with account a. FIG. 4 is a synchronization flow in the above process provided in Embodiment One of the present disclosure. As shown in FIG. 4, the synchronization flow may comprise the following steps.

In 401, terminal device A periodically uploads data in memory stack corresponding to gaming mini program 1 to the server during the running of gaming mini program 1 which is logged in with account a.

Specifically, during the running of gaming mini program 1 on terminal device A, upload may be performed in a slicing way in every cycle. That is, an area of a memory stack which has been changed in the current cycle as compared to the previous cycle is determined, and data of this area of the memory stack is uploaded to the server. In addition to the data in the memory stack, identification of terminal device A, identification of account a, identification of gaming mini program 1 and time information when the data in the memory stack is uploaded are uploaded to the server.

In 402, the server receives the data in memory stack uploaded by terminal device A and maintains correspondence between the identification of terminal device A, the identification of account a, the identification of gaming mini program 1 and the data in memory stack, wherein the data in memory stack comprises the upload time information.

Hypothetically, the currently correspondence maintained on the server comprises:

Terminal device A—Account a—Gaming Mini Program 1—data in memory stack 190312_10:05:00

Terminal device B—Account a—Gaming Mini Program 1—data in memory stack 190311_20:07:00

That is, the user used to log in and use gaming mini program 1 with account a on both terminal devices A and B. The latest data in memory stack is the data in memory stack of terminal device A identified with time information 190312_10:05:00.

In 403, terminal device B transmits a synchronization request to the server when gaming mini program 1 is opened with account a on terminal device B.

The above synchronization request contains identification of terminal device B, identification of account a and identification of gaming mini program 1.

In 404, the server transmits the latest data in memory stack corresponding to account a and gaming mini program 1 to terminal device B after receiving the synchronization request.

Continuing from the above example, the server determines the latest data in memory stack corresponding to account a and gaming mini program 1 as the data in memory stack 190312_10:05:00 uploaded by terminal device A according to the maintained correspondence, and therefore transmits the data to terminal device B.

In 405, terminal device B updates the memory stack corresponding to account a and gaming mini program 1 with the above latest data in memory stack.

After the above synchronization of the running state data is completed, for example, the server may synchronize the above latest running state data to terminal device B, followed by updating the running state data of terminal device B maintained at local. Alternatively, terminal device B may return an update success response to the server after this synchronization is completed, and the server updates the running state data of terminal device B maintained at local when the update success response is received. After updating, the data maintained at server comprises:

Terminal device A—Account a—Gaming Mini Program 1—data in memory stack 190312_10:05:00

Terminal device B—Account a—Gaming Mini Program 1—data in memory stack 190312_10:05:00

Of course, in the above process, if the server receives a synchronization request from terminal device B and determines that gaming mini program 1 which runs on terminal device B with account a is already of the latest data in memory stack according to correspondence maintained at local, there is no need to proceed with subsequent synchronization process.

Alternatively, if gaming mini program 1 is configured by the user with no synchronization permission at terminal device A, no data in memory stack will be uploaded to the server. Also, if gaming mini program 1 is configured by the user to with no synchronization permission at terminal device B, no synchronization request will be transmitted to the server.

### Embodiment Two

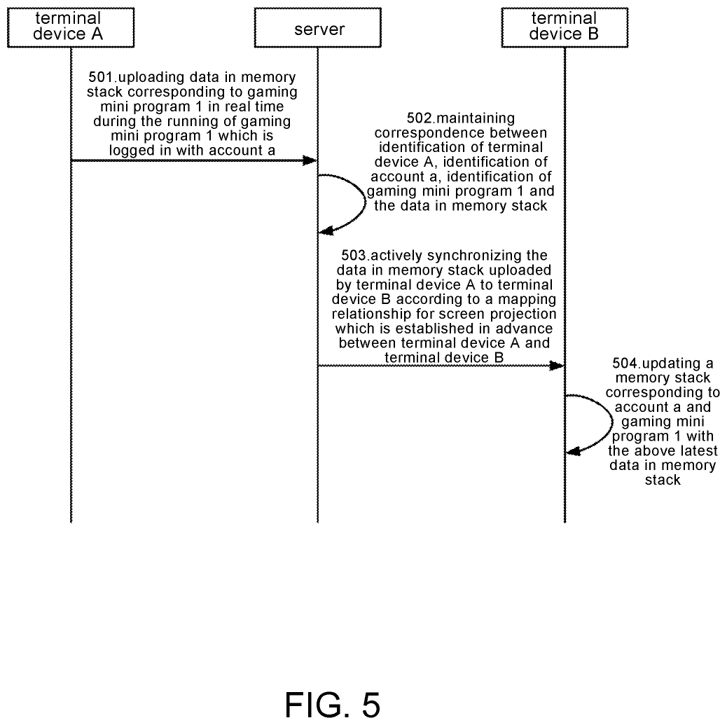

Hypothetically, a user logs in gaming mini program 1 with account a on terminal device A. Meanwhile, the user projects content from terminal device A to terminal device B by means of screen projection, so that gaming mini program 1 is also logged in with account a on terminal device B. For example, terminal device A may be a mobile phone, and terminal device B may be a television. FIG. 5 is a synchronization flow in the above process provided in Embodiment Two of the present disclosure. As shown in FIG. 5, the synchronization flow may comprise the following steps.

In 501, terminal device A uploads data in memory stack corresponding to gaming mini program 1 to the server in real time during the running of gaming mini program 1 which is logged in with account a.

Similar to Embodiment One, in addition to the data in memory stack, identification of terminal device A, identification of account a, identification of gaming mini program 1 and time information when the data in memory stack is uploaded are uploaded to the server.

In 502, the server receives the data in memory stack uploaded by terminal device A and maintains correspondence between the identification of terminal device A, the identification of account a, the identification of gaming mini program 1 and the data in memory stack, wherein the data in memory stack comprises the upload time information.

In 503, the server actively synchronizes the data in memory stack uploaded by terminal device A to terminal device B according to a mapping relationship for screen projection which is established in advance between terminal device A and terminal device B.

When the screen projection between terminal device A and terminal device B is established by a user, the mapping relationship for the screen projection will be established and maintained at the server. When the server receives data in memory stack uploaded by terminal device A, the server determines that the latest data in memory stack needs to be synchronized to terminal device B using the same account and the identical mini program according to the mapping relationship for the screen projection, in addition to maintaining correspondence between identification of terminal device A, identification of account a, identification of gaming mini program 1 and the data in memory stack.

In 504, terminal device B updates a memory stack corresponding to account a and gaming mini program 1 with the above latest data in memory stack.

Also, after above synchronization of the running state data is completed, the server updates the data in memory stack of terminal device B maintained at local.

### Embodiment Three

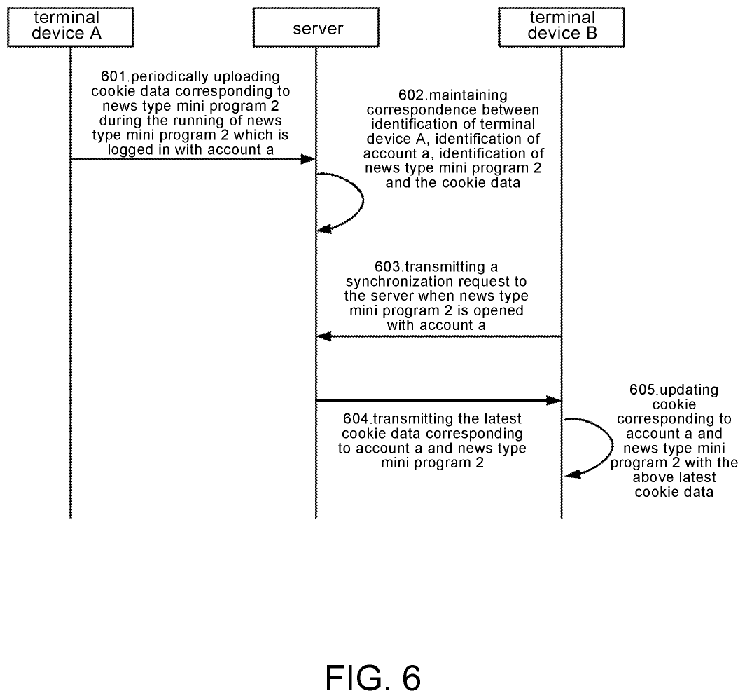

Hypothetically, after news type mini program 2 is logged in by a user with account a on terminal device A, news type mini program 2 is opened by the user on terminal device B, and is also logged in with account a. FIG. 6 is a synchronization flow in the above process provided in Embodiment Three of the present disclosure. As shown in FIG. 6, the synchronization flow may comprise the following steps.

In 601, terminal device A periodically uploads cookie data corresponding to news type mini program 2 to the server during the running of news type mini program 2 which is logged in with account a.

Generally, a news type mini program is implemented in a webview architecture. Its running state data is usually cached in cookie or localstorage. In this embodiment, cookie is used as an example.

Terminal device A uploads cookie data once in every cycle during the running of news type mini program 2. Since data amount of the cookie data is small, the cookie data may be uploaded in its entirety. Alternatively, only part of the cookie data in the current cycle which has been changed as compared to the previous cycle may be uploaded.

In 602, the server receives the cookie data uploaded by terminal device A and maintains correspondence between identification of terminal device A, identification of account a, identification of news type mini program 2 and the cookie data, wherein the cookie data comprises the upload time information.

Hypothetically, the correspondence currently maintained on the server comprises:

Terminal device A—Account a—News Type Mini Program 2—cookie data 190312_10:05:00

Terminal device B—Account a—News Type Mini Program 2—cookie data 190311_10:07:00:00

That is, the user used to log in and use news type mini program 2 with account a on both terminal devices A and B. The latest cookie data is the cookie data of terminal device A identified with time information 190312_10:05:00.

In 603, terminal device B transmits a synchronization request to the server when news type mini program 2 is opened with account a on terminal device B.

The above synchronization request contains identification of terminal device B, identification of account a and the identification of news type mini program 2.

In 604, the server synchronizes the latest cookie data corresponding to account a and news type mini program 2 to terminal device B after receiving the synchronization request.

Continuing from the above example, the server determines the latest cookie data corresponding to account a and news type mini program 2 as the cookie data 190312_10:05:00 uploaded by terminal device A according to the maintained correspondence, and therefore transmits the data to terminal device B.

In 605, terminal device B updates cookie corresponding to account a and news type mini program 2 with the above latest cookie data.

After the above synchronization of the running state data is completed, for example, the server may synchronize the above latest running state data to terminal device B, followed by updating the running state data of terminal device B maintained at local. Alternatively, terminal device B may return an update success response to the server after this synchronization is completed, and the server updates the running state data of terminal device B maintained at local when the update success response is received. After updating, the data maintained at server comprises:

Terminal device A—Account a—News Type Mini Program 2—cookie data 190312_10:05:00

Terminal device B—Account a—News Type Mini Program 2—cookie data 190312_10:05:00 Of course, in the above process, if the server receives a synchronization request from terminal device B and determines that news type mini program 2 which runs on terminal device B with account a is already of the latest cookie according to correspondence maintained at local, there is no need to proceed with subsequent synchronization process.

Alternatively, if news type mini program 2 is configured by the user with no synchronization permission at terminal device A, no cookie data will be uploaded to the server. Also, if news type mini program 2 is configured by the user with no synchronization permission at terminal device B, no synchronization request will be transmitted to the server.

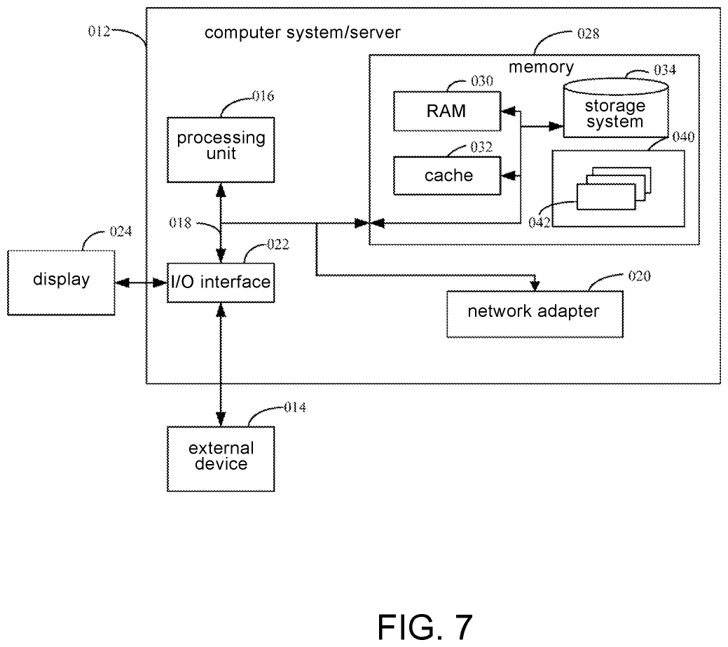

FIG. 7 shows a block diagram of an exemplary computer system/server 012 suitable for implementing the embodiments of the present disclosure. The computer system/server 012 shown in FIG. 7 is merely an example, and should not impose any limitation on the functions and scope of use of the embodiments of the present disclosure.

As shown in FIG. 7, the computer system/server 012 is embodied as a general-purpose computing device. Components of the computer system/server 012 may include but are not limited to one or more processors or processing units 016, a system memory 028, a bus 018 connecting different system components (including the system memory 028 and the processing unit 016).

The bus 018 represents one or more of several types of bus structures, including a memory bus or a memory controller, a peripheral bus, a graphics acceleration port, a processor, or a local area bus using any of a variety of bus structures. By way of example, these architectures include, but are not limited to, an Industry Standard Architecture (ISA) bus, a Micro Channel Architecture (MAC) bus, an enhanced ISA bus, a Video Electronics Standards Association (VESA) local area bus, and a peripheral component interconnect (PCI) bus.

Computer system/server 012 typically includes a variety of computer system readable media. These media can be any available media that can be accessed by the computer system/server 012, including volatile and non-volatile media, removable and non-removable media.

The system memory 028 may include computer system readable media in the form of a volatile memory, such as a random access memory (RAM) 030 and/or a cache memory 032. Computer system/server 012 may further include other removable/non-removable, volatile/nonvolatile computer system storage media. By way of example only, the storage system 034 may be used to read and write non-removable, non-volatile magnetic media (not shown in FIG. 7 and is commonly referred to as a “hard drive”). Although not shown in FIG. 7, a magnetic disk drive for reading and writing to a removable non-volatile magnetic disk (for example, “a floppy disk”) and an optical disk drive for reading and writing to a removable non-volatile optical disk (for example, CD-ROM, DVD-ROM or other optical media) may be provided. In these cases, each drive may be connected to the bus 018 through one or more data media interfaces. The memory 028 may include at least one program product having a set of (e.g., at least one) program modules configured to perform the functions of the embodiments of the present disclosure.

A program/utility tool 040 having a set of (at least one) program modules 042 may be stored in, for example, the memory 028. Such program modules 042 include, but are not limited to, an operating system, one or more application programs, other programs modules and program data, each or some combination of these examples may include implementations of the network environment. The program module 042 generally performs functions and/or methods in the embodiments described in the present disclosure.

The computer system/server 012 can also communicate with one or more external devices 014 (e.g., a keyboard, a pointing device, a display 024, etc.). In the present disclosure, the computer system/server 012 can communicate with external radar devices, and can also communicate with one or more devices that enable users to interact with the computer system/server 012, and/or with any device (such as a network card, a modem, etc.) that enables the computer system/server 012 to communicate with one or more other computing devices. Such communication can be performed through an input/output (I/O) interface 022. Moreover, the computer system/server 012 can also communicate with one or more networks (such as a local area network (LAN), a wide area network (WAN), and/or a public network, such as the Internet) through a network adapter 020. As shown in the figures, the network adapter 020 communicates with other modules of the computer system/server 012 through the bus 018. It should be understood that although not shown in FIG. 7, other hardware and/or software modules may be used in conjunction with the computer system/server 012, including but not limited to: microcode, device drivers, redundant processing units, external disk drive arrays, RAID systems, tape drives and data backup storage systems.

The processing unit 016 performs various functional applications and data processing, such as implementing the method flows provided by the embodiments of the present disclosure, by executing programs stored in the system memory 028.

The above-mentioned computer program may be set in a computer storage medium, that is, the computer storage medium is encoded with a computer program, which when executed by one or more computers, causes the one or more computers to execute the method flow and/or apparatus operations shown in the above-described embodiments of the present disclosure. For example, the method flow provided in the embodiments of the present disclosure is executed by the above-described one or more processors.

With the development of time and technology, the meaning of media has become more and more extensive. The propagation method of computer programs is no longer limited to tangible media. Computer programs can also be downloaded directly from the network. Any combination of one or more computer-readable media may be used. The computer-readable media may be computer-readable signal media or computer-readable storage media. The computer-readable storage media may be, for example, but not limited to, an electronic, magnetic, optical, electromagnetic, infrared, or semiconductor system, apparatus, or device, or any combination thereof. More specific examples (non-exhaustive list) of computer-readable storage media may include: electrical connections with one or more wires, portable computer magnetic disks, hard disks, a random access memory (RAM), a read-only memory (ROM), an erasable programming read-only memory (EPROM or flash memory), an optical fiber, a portable compact disk read-only memory (CD-ROM), an optical storage device, a magnetic storage device, or any suitable combination of the foregoing. In the present document, the computer-readable storage media may be any tangible media that contain or store programs that can be used by or in combination with an instruction execution system, apparatus, or device.

Computer-readable signal media may include a data signal that is included in a baseband or propagated as part of a carrier wave, and which carries computer-readable program code. Such a propagated data signal may take many forms, including but not limited to electromagnetic signals, optical signals, or any suitable combination of the foregoing. The computer-readable signal media may also be any computer-readable media other than computer-readable storage media, and the computer-readable media may send, propagate, or transmit a program for use by or in connection with an instruction execution system, apparatus or device.

Program code embodied on computer-readable media may be transmitted using any appropriate media, including but not limited to: wireless, wired, optical fiber cable, RF, etc., or any suitable combination of the foregoing.

Computer program code for performing the operations of the present disclosure may be written in one or more programming languages, or a combination thereof, including object oriented programming languages such as Java, Smalltalk, C++, and conventional procedural programming language, such as “C” or similar programming language. The program code can be executed entirely on the user's computer, partly on the user's computer, as an independent software package, partly on the user's computer and partly on a remote computer, or entirely on a remote computer or server. In the case of a remote computer, the remote computer can be connected to the user's computer through any kind of network, including a local area network (LAN) or wide area network (WAN), or it can be connected to an external computer (for example through Internet connection provided by an Internet service provider).

As seen from the above description, the methods, apparatuses, and computer storage media provided in the embodiments of the present disclosure may have the following advantages:

1) synchronization of running state of mini programs across devices are enabled in the present application.

2) For different types of mini programs, a variety of methods are provided for synchronizing running state data such as data in memory stack, cookie data, data in localstorage, etc.

3) State synchronization permission of mini programs may be specified by users through a configuration interface, in addition to the mini program developers.

The above are only embodiments of the present disclosure, and are not intended to limit the present disclosure. Any modification, equivalent replacement, and improvement made within the spirit and principle of the present disclosure should be included in the protection scope of the present disclosure.

What is claimed is:

1. A method for state synchronization of mini programs, the method comprising:
uploading, by a first terminal device, running state data of a mini program which is currently running to a server, so that the server synchronizes the running state data to an identical mini program which runs on a second terminal device with a same account.

2. The method as recited in claim 1, wherein the running state data comprises: data in memory stack or data in running state cache of the mini program; and
wherein the running state cache comprises: cookie or localstorage.

3. The method as recited in claim 2, wherein before uploading, by the first terminal device, the running state data of the mini program which is currently running to the server, the method further comprising:
determining, by the first terminal device, whether the mini program is a mini program which is configured with state synchronization permission; and if so, proceeding to upload the running state data of the mini program which is currently running to the server; otherwise, not uploading the running state data of the mini program which is currently running to the server.

4. The method as recited in claim 1, wherein the uploading comprising: uploading the running state data of the mini program which has been changed in real time or periodically.

5. The method as recited in claim 1, wherein the method further comprising:
receiving and maintaining, by the server, the running state data of the mini program which is currently running uploaded by the first terminal device.

6. The method as recited in claim 5, wherein the method further comprising:
maintaining, by the server, correspondence between terminal device identification, account identification, mini program identification and the running state data, and wherein the running state data comprises time information.

7. The method as recited in claim 6, wherein the synchronizing the running state data to the identical mini program which runs on the second terminal device with the same account comprising:
receiving, by the server, a synchronization request from the second terminal device and synchronizing the latest running state data corresponding to the identical mini program with the same account to the second terminal device according to the correspondence; or
actively synchronizing the latest running state data corresponding to the identical mini program with the same account to the second terminal device according to the correspondence.

8. The method as recited in claim 7, wherein actively synchronizing, by the server, the latest running state data corresponding to the identical mini program with the same account to the second terminal device according to the correspondence if a mapping relationship for screen projection is established between the first terminal device and the second terminal device in advance.

9. The method as recited in claim 7, wherein the method further comprising:
updating, by the server, running state data of the second terminal device maintained on the server with the running state data.

10. The method as recited in claim 1, the method further comprising:
receiving, by the second terminal device, the running state data transmitted by the server; and
updating the identical mini program which runs on the second terminal device with the same account with the running state data.

11. The method as recited in claim 10, wherein before receiving, by the second terminal device, the running state data transmitted by the server, the method further comprising:
transmitting a synchronization request to the server when the identical mini program is opened on the second terminal device with the same account; or
transmitting a synchronization request to the server when the identical mini program is logged in with the same account on the second terminal device.

12. The method as recited in claim 11, wherein before transmitting the synchronization request to the server, the method further comprising:
determining, by the second terminal device, whether the mini program is a mini program which is configured with state synchronization permission, and if so, proceeding to transmit the synchronization request to the server; otherwise, not transmitting the synchronization request to the server.

13. A device, comprising:
one or more processors; and
storage means for storing one or more programs,
wherein the one or more programs, when executed by the one or more processors, cause the one or more processors to:
upload running state data of a mini program which is currently running to a server, so that the server synchronizes the running state data to an identical mini program which runs on a second terminal device with a same account.

14. A storage medium comprising computer-executable instructions, wherein the computer-executable instructions, when executed by a processor of a first terminal device, cause the processor to:
upload running state data of a mini program which is currently running to a server, so that the server synchronizes the running state data to an identical mini program which runs on a second terminal device with a same account.
